(19) United States
(12) Patent Application Publication
(10) Pub. No.: US 2014/0055418 A1
(43) Pub. Date: Feb. 27, 2014

(54) TOUCH DISPLAY PANEL AND OPTICAL TOUCH PANEL THEREOF

(71) Applicant: WINTEK CORPORATION, Taichung City (TW)

(72) Inventors: Tsung-Yen Hsieh, Taichung City (TW); Chong-Yang Fang, Taichung City (TW); Tsung-Hsien Lin, Taichung City (TW)

(73) Assignee: WINTEK CORPORATION, Taichung City (TW)

(21) Appl. No.: 13/970,626

(22) Filed: Aug. 20, 2013

(30) Foreign Application Priority Data
Aug. 21, 2012 (TW) 101130236
Aug. 9, 2013 (TW) 102128705

(51) Int. Cl. G06F 3/042

(52) U.S. Cl. CPC G06F 3/042
USPC 345/175

(57) ABSTRACT

An optical touch panel includes a transparent light guide plate, at least one light emitting device, a bottom reflective sheet and at least one light sensing device. The transparent light guide plate has a top surface, a bottom surface and at least one light incident surface. The top surface of the transparent light guide plate is for touch input. The light emitting device faces the light incident surface for emitting a light beam toward the light incident surface. The bottom reflective sheet faces the bottom surface of the transparent light guide plate. A light reflection space is formed between the bottom surface of the transparent light guide plate and the reflective sheet. The light sensing device is disposed on at least one side of the light reflection space for sensing the light beam reflected from the light reflection space.

### CROSS REFERENCE TO RELATED APPLICATION

This application claims foreign priority benefits to TW patent application serial No. 101130236 filed Aug. 21, 2012 and TW patent application serial No. 102128705 filed Aug. 9, 2013, each of which is hereby incorporated by reference in its entirety.

### BACKGROUND OF THE INVENTION

1. Field of the Invention

The present invention relates to a touch display panel and an optical touch panel thereof, and more particularly, to a touch display panel and an optical touch panel that use a transparent light guide plate and a bottom reflective sheet as a reflection path for light beam.

2. Description of the Prior Art

Due to its human-machine interactive characteristic, touch panel has been widely used in the input interface of various types of electronic products. Touch panels are classified into three main types: resistive type, capacitive type and optical type based on different touch input mechanisms. The optical touch panel prevails in the application of large size display panel for resistive touch panel and capacitive touch panel suffer from low yield and high cost. However, the development of optical touch panel is limited for it cannot satisfy the requirement of thin thickness and slim border for touch display panel.

### SUMMARY OF THE INVENTION

It is therefore one of the objectives of the present invention to provide a touch display panel and an optical touch panel with slim border and flat surface.

According to a preferred embodiment, an optical touch panel is provided. The optical touch panel includes a transparent light guide plate, at least one light emitting device, a bottom reflective sheet and at least one light sensing device. The transparent light guide plate has a top surface, a bottom surface and at least one light incident surface, wherein the top surface is for touch inputting. The light emitting device faces the light incident surface of the transparent light guide plate for emitting a light beam toward the light incident surface. The bottom reflective sheet faces the bottom surface of the transparent light guide plate, wherein a light reflection space exists between the bottom surface of the transparent light guide plate and the bottom reflective sheet. The light sensing device is disposed on at least one side of the light reflection space for sensing the light beam reflected by the light reflection space.

According to another preferred embodiment, a touch display panel is provided. The touch display panel includes a display panel and the aforementioned optical touch panel. The display panel has a display surface. The bottom surface of the transparent light guide plate of the aforementioned optical touch panel faces the display surface of the display panel.

According to still another preferred embodiment, a touch display panel is provided. The touch display panel includes a display panel and an optical touch panel. The display panel has a display surface. The optical touch panel includes a transparent light guide plate, at least one light emitting device and at least one light sensing device. The transparent light guide plate has a top surface, a bottom surface and at least one light incident surface, wherein the top surface is for touch inputting, the bottom surface faces the display surface of the display panel, and an light reflection space exists between the bottom surface of the transparent light guide plate and the display surface of the display panel. The light emitting device faces the light incident surface of the transparent light guide plate for emitting a light beam toward the light incident surface. The light sensing device is disposed on at least one side of the light reflection space for sensing the light beam reflected by the light reflection space.

According to yet another preferred embodiment, an optical touch panel is provided. The optical touch panel includes a transparent light guide plate, a light emitting array, a light sensing array and a first light coupling layer. The transparent light guide plate has a top surface, a bottom surface and a plurality of side surfaces connected to the top surface and the bottom surface, wherein the top surface is for touch inputting. The light emitting array is for emitting a light beam toward the transparent light guide plate, and the light emitting array includes a plurality of light emitting devices. The light sensing array is for sensing the light beam coming out of the transparent light guide plate, and the light sensing array includes a plurality of light sensing devices. The first light coupling layer is disposed between the transparent light guide plate and the light sensing array for coupling the light beam inside the transparent light guide plate to the light sensing array.

The touch display panel and the optical touch panel disclosed of the present invention use the transparent light guide plate and the bottom reflective sheet as light reflection path, and thus the border can be reduced to satisfy the slim border requirement. In addition, the light sensing device is disposed on the edge of the light reflection space, and the aperture ratio of the display panel remains unaffected. Furthermore, no devices are disposed on the surface of the touch display panel, and thus the touch display panel has full flat surface display effect. The touch display panel and the optical touch panel of the present invention dispose the light emitting array and the light sensing array on the side surface or the peripheral region of the bottom surface of the transparent light guide plate, and thus the border can be reduced to satisfy the slim border requirement. In addition, the aperture ratio of the display panel remains unaffected and the touch display panel has full flat surface display effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded view of an optical touch panel of a first preferred embodiment of the present invention.

FIG. 2 is a cross-section view of an optical touch panel of a first preferred embodiment of the present invention.

FIG. 3 is an exploded view of an optical touch panel of a second preferred embodiment of the present invention.

FIG. 4 is an exploded view of an optical touch panel of a third preferred embodiment of the present invention.

FIG. 5 is a schematic diagram of a touch display panel of a first preferred embodiment of the present invention.

FIG. 6 is a cross-section view of the touch display panel of FIG. 5.

FIG. 7 is a schematic diagram of a touch display panel of a first modified embodiment of the first preferred embodiment of the present invention.

FIG. 8 is a schematic diagram of a touch display panel of a second modified embodiment of the first preferred embodiment of the present invention.

FIG. 9 and FIG. 10 are schematic diagrams illustrating an optical display panel of a fourth preferred embodiment of the present invention when no touch input is implemented.

FIG. 11 is a schematic diagram illustrating an optical display panel of a fourth preferred embodiment of the present invention when touch input is implemented.

FIG. 12 and FIG. 13 are schematic diagrams illustrating an optical touch panel of a fifth preferred embodiment of the present invention when no touch input is implemented.

FIG. 14 is a schematic diagram illustrating an optical touch panel of a fifth preferred embodiment of the present invention when a touch input is implemented.

FIG. 15 is a top view of an optical touch panel of a sixth preferred embodiment of the present invention.

FIG. 16 is a cross-sectional view of an optical touch panel of a sixth preferred embodiment of the present invention.

FIG. 17 and FIG. 18 are schematic diagrams illustrating an optical touch panel of a seventh preferred embodiment of the present invention.

FIG. 19 is a schematic diagram illustrating an optical touch panel of an eighth preferred embodiment of the present invention.

FIG. 20 is a schematic diagram illustrating an optical touch panel of a ninth preferred embodiment of the present invention.

FIG. 21 is a schematic diagram of a touch display panel of a second preferred embodiment of the present invention.

### DETAILED DESCRIPTION

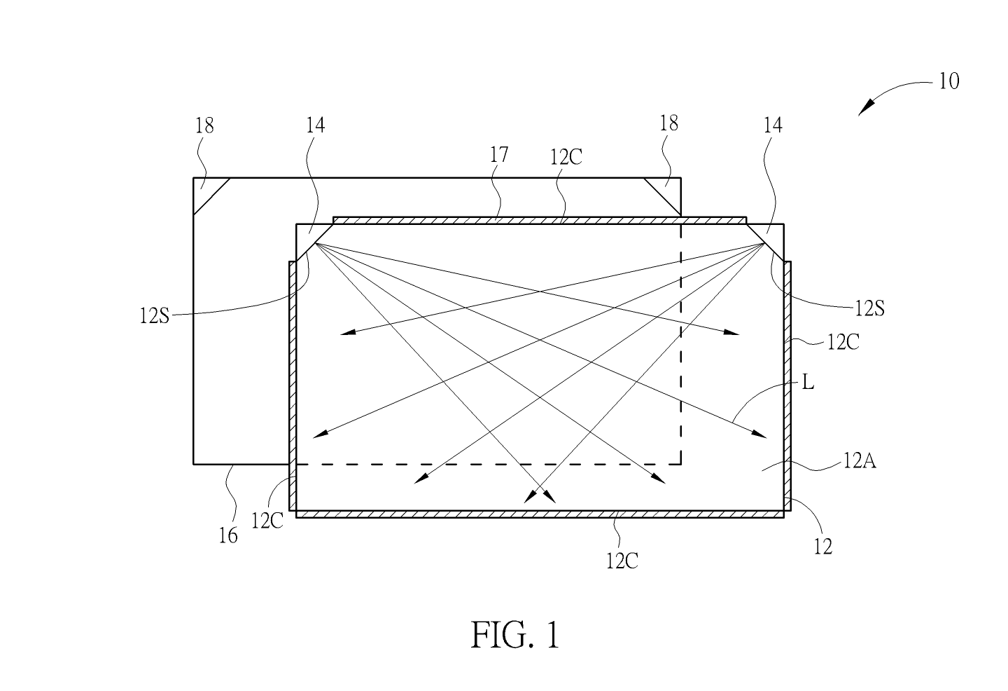

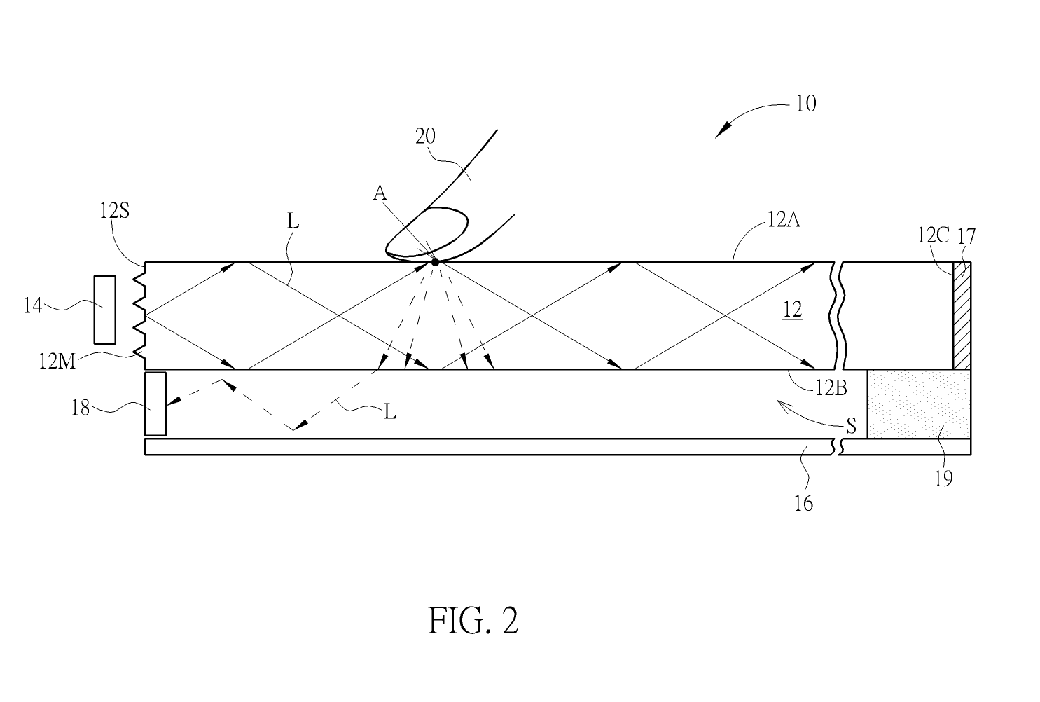

Refer to FIG. 1 and FIG. 2. FIG. 1 is an exploded view of an optical touch panel of a first preferred embodiment of the present invention, and FIG. 2 is a cross-section view of an optical touch panel of a first preferred embodiment of the present invention. As shown in FIG. 1 and FIG. 2, the optical touch panel 10 of this embodiment includes a transparent light guide plate (LGP) 12, at least one light emitting device 14, a bottom reflective sheet 16 and at least one light sensing device 18. The transparent LGP 12 has a top surface 12A, a bottom surface 12B, at least one side surface 12C and at least one light incident surface 12S, where the top surface 12A is for touch inputting. The material of the transparent LGP 12 may be, for example, acrylic resin or glass, but not limited thereto. The light emitting device 14 faces the light incident surface 12S of the transparent LGP 12 for emitting a light beam L toward the light incident surface 12S. The light emitting device 14 may include one or more light emitting components, and the light beam L may be a visible light beam or an invisible light beam e.g. infrared beam. The light beam L emitted by the light emitting device 14 covers the entirety of the top surface 12A of the transparent LGP 12. The number and location of the light emitting device 14 may be modified based on the viewing angle (also referred to beam angle) of the light beam L. The light incident surface 12S may include, but not limited to, a plurality of micro structures (also referred to fine structures) 12M (as shown in FIG. 2) in order to increase the amount of incident light and to diffuse the light beam L, but not limited thereto. For example, the light incident surface 12S of the transparent LGP 12 may be a flat surface. The micro structures 12M may be various types of regular or irregular geometric structures. The bottom reflective sheet 16 faces the bottom surface 12B of the transparent LGP 12, and a gap exists between the bottom surface 12B and the bottom reflective sheet 16, which forms a light reflection space S. The bottom reflective sheet 16 provides reflection effect, and may further provide scattering effect. The light sensing device 18 is disposed on at least one side of the light reflection space S for sensing the light beam L reflected out of the light reflection space S.

The optical touch panel 10 may further include at least one side reflective sheet 17 and a sealant 19 (now shown in FIG. 1). The side reflective sheet 17 is disposed on the side surface 12C of the transparent LGP 12 for reflecting the light beam L coming out of the side surface 12C back into the transparent LGP 12. The sealant 19 is disposed between the transparent LGP 12 and the bottom reflective sheet 16, and corresponding to the edge of the transparent LGP 12 and the bottom reflective sheet 16 for supporting the transparent LGP 12 and maintaining the light reflection space S.

In this invention, the refractive index of the transparent LGP 12 and that of the medium (e.g. air) in contact with the transparent LGP 12 are different. For example, the refractive index of the transparent LGP 12 is higher than that of air. When no touch inputting is implemented, total internal reflection (TIR) occurs inside the transparent LGP 12 since the angle of most of the light beam L is greater than the critical angle, and thus most of the light beam L will not come out of the transparent LGP 12. When a user puts a touch input device 20 such as his finger on an input point A of the top surface 12A of the transparent LGP 12 to implement touch input, the total internal reflection will be destroyed due to the contact of the touch input device 20 and the top surface 12A of the transparent LGP 12. Accordingly, the light beam L at the input point A is reflected by the touch input device 20. Since the angle of most of the reflected light beam L is less than the critical angle, the reflected light beam L will penetrate through the bottom surface 12B of the transparent LGP 12 and enter the light reflection space S. In the light reflection space S, the light beam L is reflected by the bottom surface 12B of the transparent LGP 12 and the bottom reflective sheet 16 to and fro, and received by the light sensing device 18 disposed on at least one side of the light reflection space S. Consequently, the coordinates of the input point A are calculated.

As shown in FIG. 1, in this embodiment, there are two light emitting devices 14, respectively disposed at two adjacent corners of the transparent LGP 12. In other words, there are two light incident surfaces 12S disposed at two adjacent corners of the transparent LGP 12, and the two light emitting devices 14 face the two light incident surfaces 12S, respectively. In addition, there are two or more light sensing devices 18. For example, there are two light sensing devices 18 respectively disposed at two adjacent corners of the light reflection space S, but not limited thereto. Furthermore, the optical touch panel 10 may further include a third light sensing device (not shown) disposed at another corner of the light reflection space S to check if a touch input is erroneously detected.

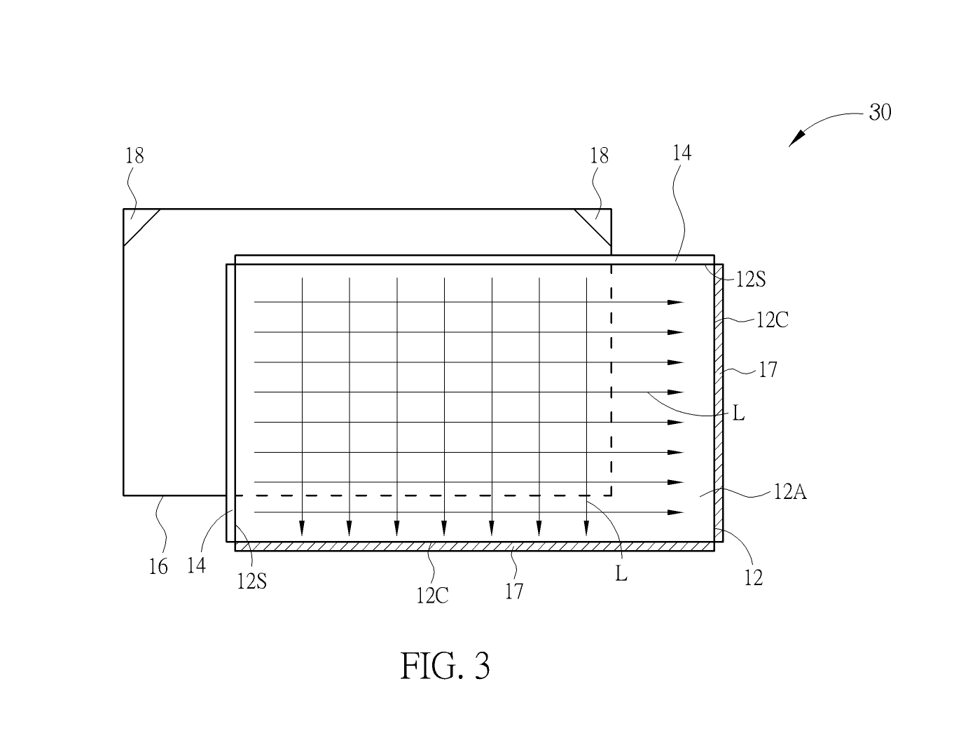

Refer to FIG. 3, as well as FIG. 2. FIG. 3 is an exploded view of an optical touch panel of a second preferred embodiment of the present invention. As shown in FIG. 3, the optical touch panel 30 includes two light emitting devices 14 facing two adjacent light incident surfaces 12S of the transparent LGP 12, respectively. Each light emitting device 14 may be a light bar, which includes a plurality of light emitting components for emitting the light beam L. The side reflective sheet 17 is disposed on two adjacent side surfaces 12C of the transparent LGP 12. The number of the light sensing devices 18 may be two or more. For instance, there are two light sensing devices 18 disposed at two adjacent corners of the light reflection space S, but not limited thereto. Furthermore, the optical touch panel 30 may further include a third light sensing device (not shown) disposed at another corner of the light reflection space S to check if a touch input is erroneously detected.

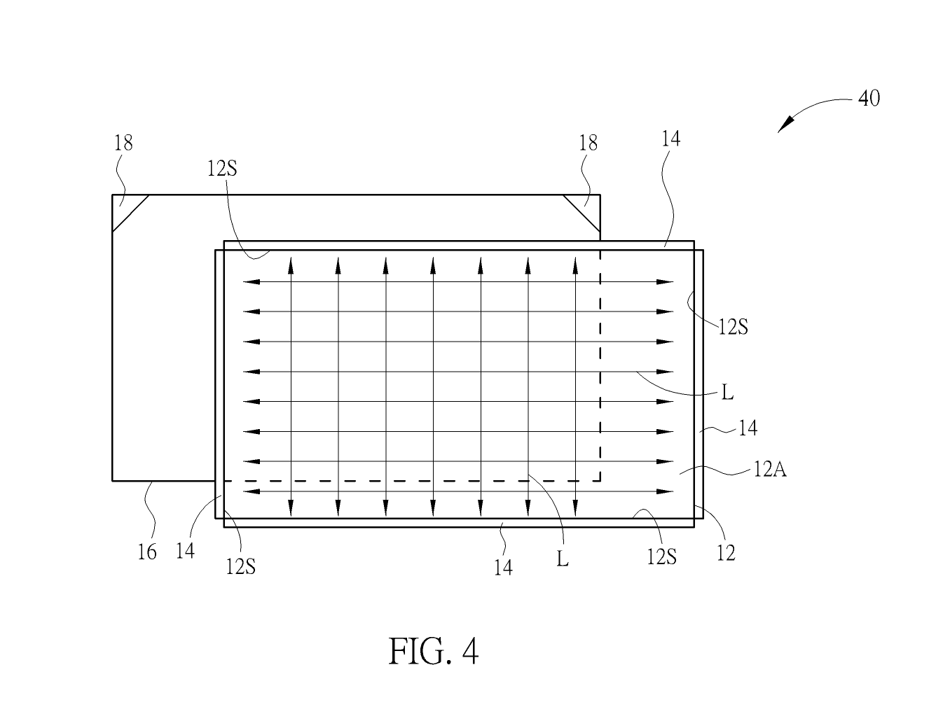

Refer to FIG. 4, as well as FIG. 2. FIG. 4 is an exploded view of an optical touch panel of a third preferred embodiment of the present invention. As shown in FIG. 4, the optical touch panel 40 includes four light emitting devices 14 disposed on four light incident surfaces 12S of the transparent LGP 12, respectively. Each light emitting device 14 may be a light bar, which includes a plurality of light emitting components for emitting the light beam L. The number of the light sensing devices 18 may be two or more. For instance, there are two light sensing devices 18 disposed at two adjacent corners of the light reflection space S, but not limited thereto. Furthermore, the optical touch panel 40 may further include a third light sensing device (not shown) disposed at another corner of the light reflection space S to check if a touch input is erroneously detected.

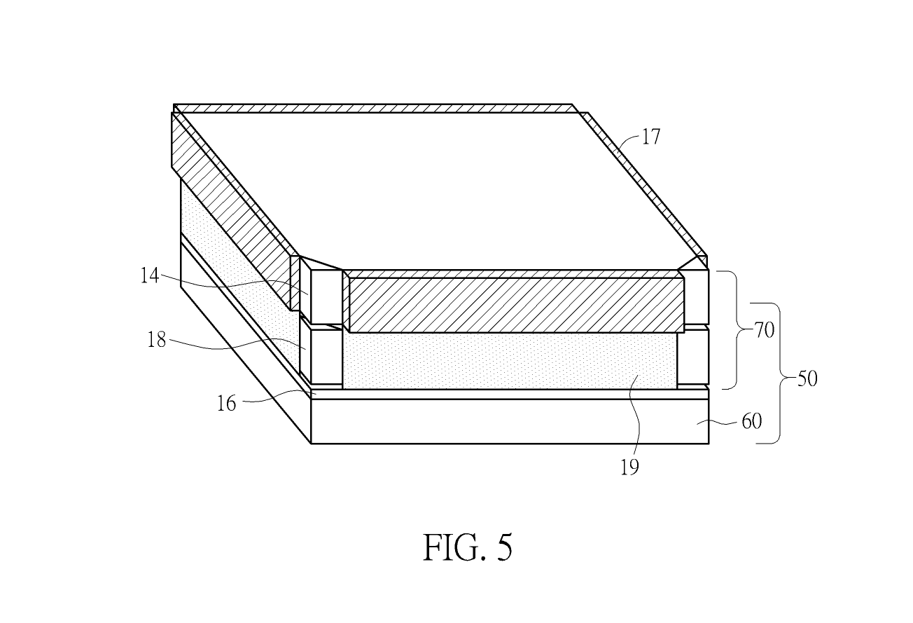

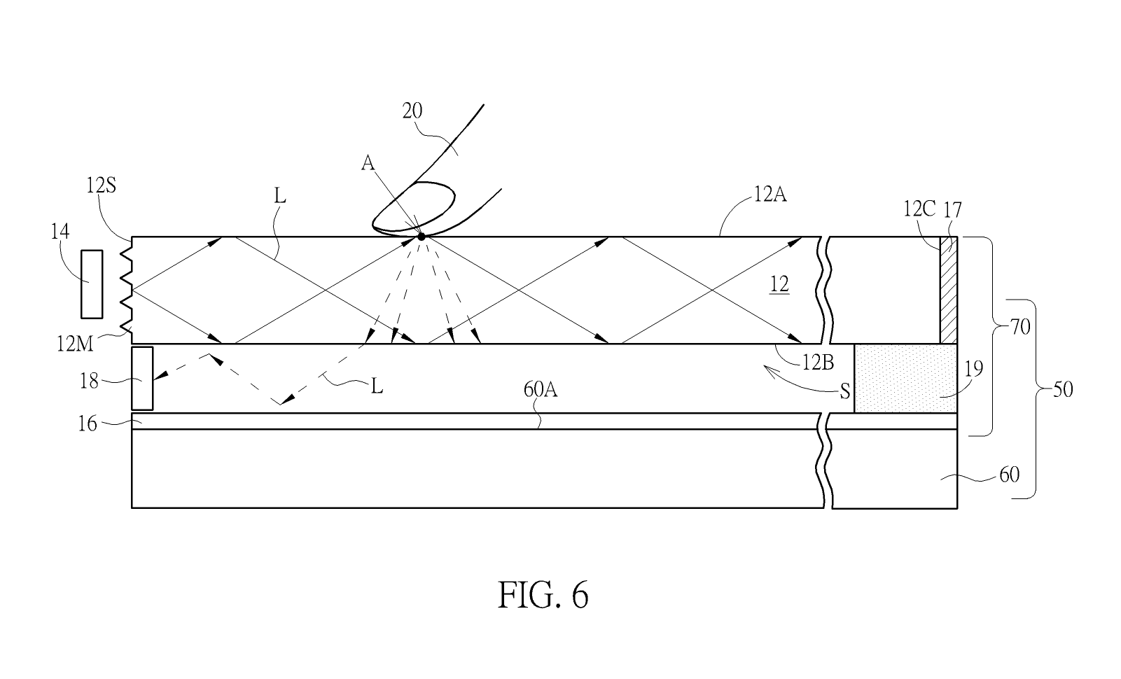

Refer to FIG. 5 and FIG. 6, as well as FIGS. 1-4. FIG. 5 is a schematic diagram of a touch display panel of a first preferred embodiment of the present invention, and FIG. 6 is a cross-section view of the touch display panel of FIG. 5. As shown in FIG. 5 and FIG. 6, the touch display panel 50 includes a display panel 60 and an optical touch panel 70. The display panel 60 has a display surface 60A. The display panel 60 may be a self-luminous display panel such as organic electroluminescent display panel, plasma display panel, field emitting display panel, etc., or a non self-luminous display panel such as a liquid crystal display panel, an electrowetting display panel, an electrophoretic display panel, etc. In this embodiment, the optical touch panel 70 is selected from the optical touch panel of FIG. 1, but not limited. For example, the optical touch panel 70 may be selected from any one of the optical touch panels of FIGS. 2-4. The components and arrangement of the optical touch panel 70 are illustrated in the aforementioned embodiments, and are not redundantly described. In this embodiment, the bottom reflective sheet 16 is a transparent bottom reflective sheet, which allows the image displayed by the display panel 60 to pass through. The touch display panel 50 may further include at least one side reflective sheet 17 and a sealant 19. The side reflective sheet 17 is disposed on the side surface 12C of the transparent LGP 12 for reflecting the light beam L coming out of the side surface 12C back into the transparent LGP 12. The sealant 19 is disposed between the transparent LGP 12 and the bottom reflective sheet 16, and corresponding to the edge of the transparent LGP 12 and the bottom reflective sheet 16 for supporting the transparent LGP 12 and maintaining the light reflection space S.

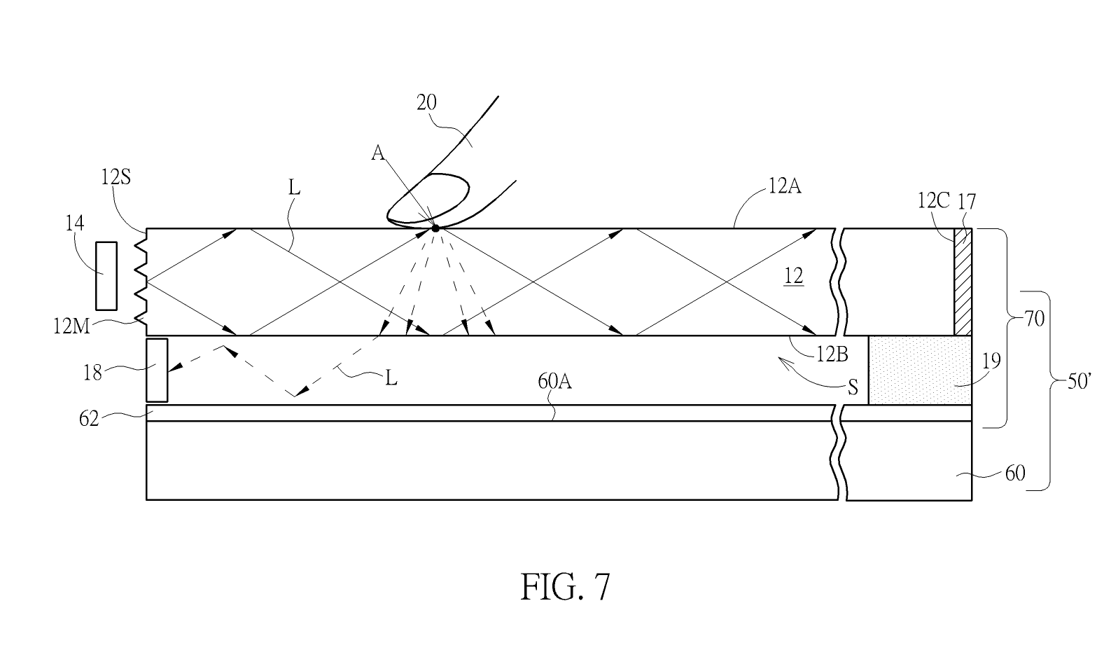

Refer to FIG. 7. FIG. 7 is a schematic diagram of a touch display panel of a first modified embodiment of the first preferred embodiment of the present invention. As shown in FIG. 7, in the touch display panel 50′ of the first modified embodiment, the bottom reflective sheet of the optical touch panel 70 and one optical film disposed on the display surface 60A of the display panel 60 into one piece of optical film. For example, the display panel 60 is a liquid crystal display panel, and a polarizing sheet 62, which can provide reflection effect, is used as a bottom reflective sheet. Therefore, no extra bottom reflective sheet is required. In addition, in another modified embodiment, any other optical film that has reflection effect can be used as the bottom reflective sheet, and thus no extra bottom reflective sheet is required. The touch display panel 50′ may further include at least one side reflective sheet 17 and a sealant 19. The side reflective sheet 17 is disposed on the side surface 12C of the transparent LGP 12 for reflecting the light beam L coming out of the side surface 12C back into the transparent LGP 12. The sealant 19 is disposed between the transparent LGP 12 and the polarizing sheet 62, and corresponding to the edge of the transparent LGP 12 and the polarizing sheet 62 for supporting the transparent LGP 12 and maintaining the light reflection space S.

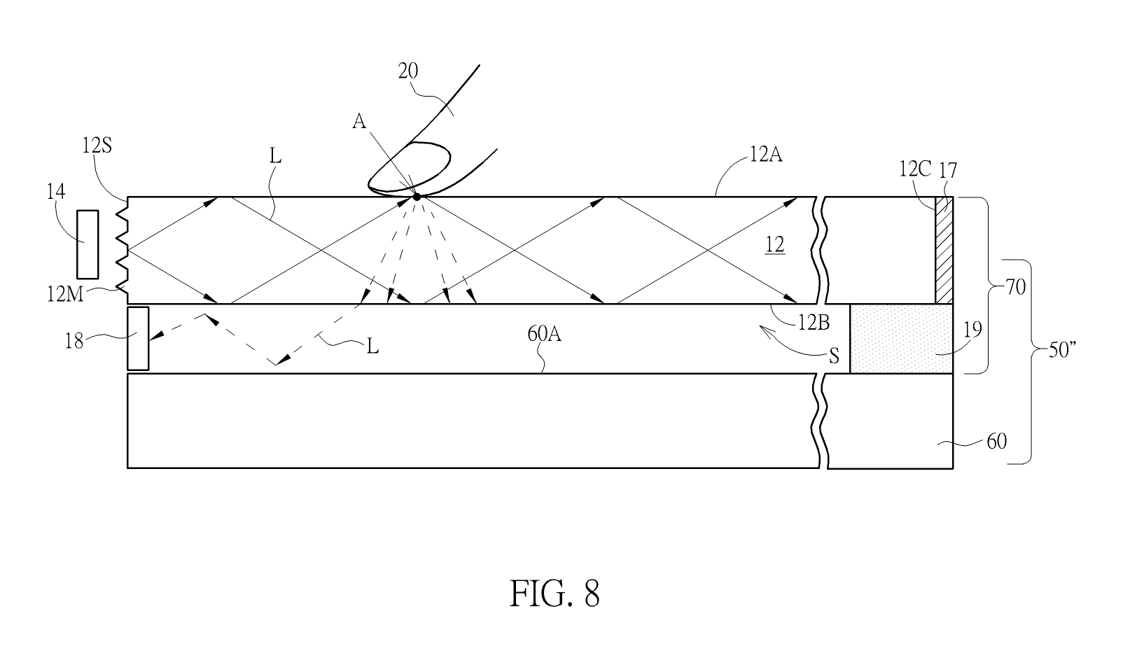

Refer to FIG. 8. FIG. 8 is a schematic diagram of a touch display panel of a second modified embodiment of the first preferred embodiment of the present invention. As shown in FIG. 8, in the touch display panel 50″ of the second modified embodiment, the optical touch panel 70 does not include bottom reflective sheet, and the light reflection space S is formed between the bottom surface 12B of the transparent LGP 12 and the display surface 60A of the display panel 60. In other words, the display surface 60A of the display panel 60 can provide reflection effect, and thus no extra bottom reflective sheet or optical film for reflection is required. The touch display panel 50″ may further include at least one side reflective sheet 17 and a sealant 19. The side reflective sheet 17 is disposed on the side surface 12C of the transparent LGP 12 for reflecting the light beam L coming out of the side surface 12C back into the transparent LGP 12. The sealant 19 is disposed between the transparent LGP 12 and the display surface 60A of the display panel 60, and corresponding to the edge of the transparent LGP 12 and the display panel 60 for supporting the transparent LGP 12 and maintaining the light reflection space S.

The touch display panel and the optical touch panel disclosed in FIGS. 1-8 of the present invention use the transparent LGP and the bottom reflective sheet as light reflection path, and thus the border can be reduced to satisfy the slim border requirement. In addition, the light sensing device is disposed on the edge of the light reflection space, and the aperture ratio of the display panel remains unaffected. Furthermore, no devices are disposed on the surface of the touch display panel, and thus the touch display panel has full flat surface display effect.

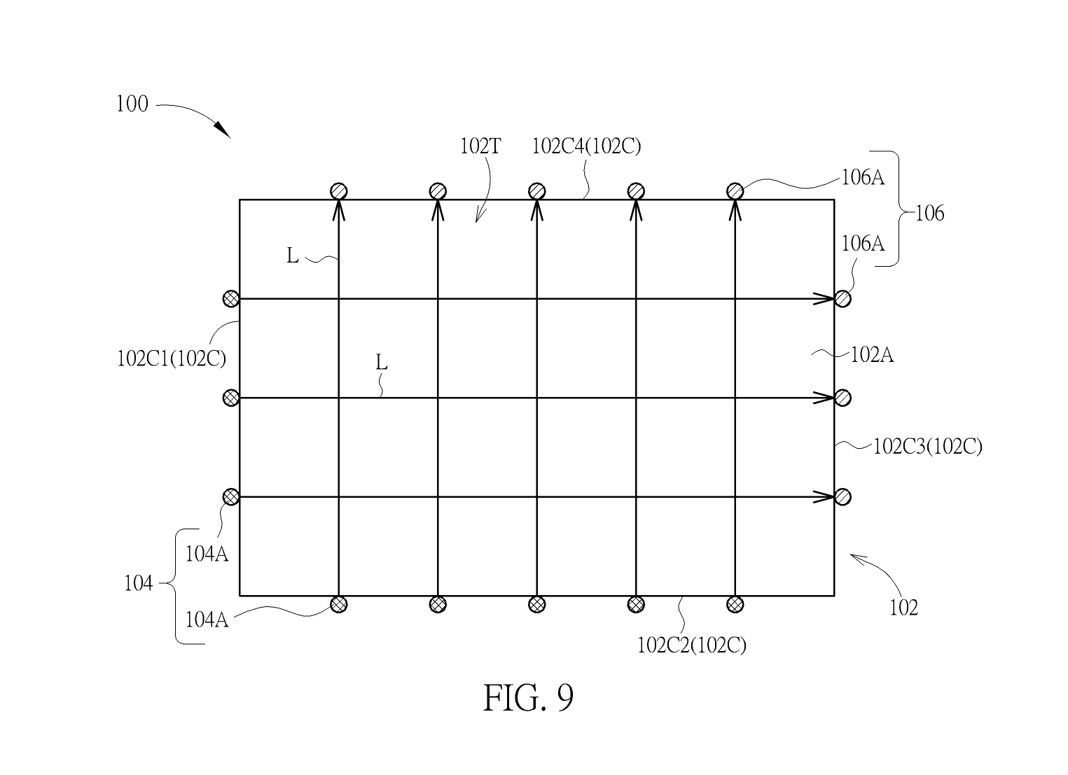

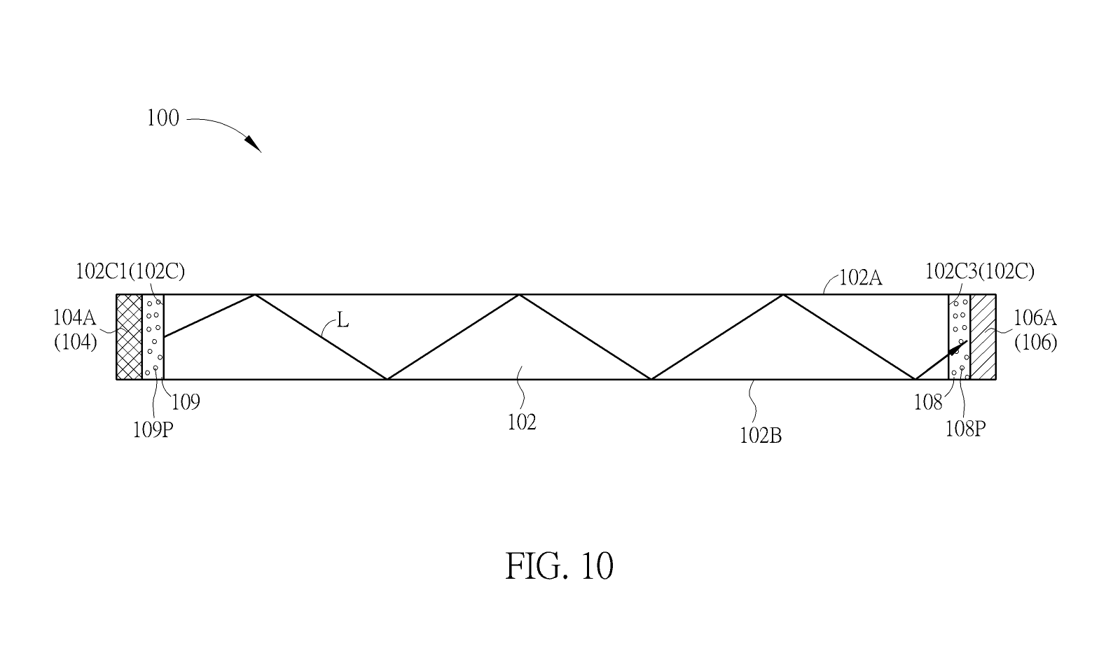

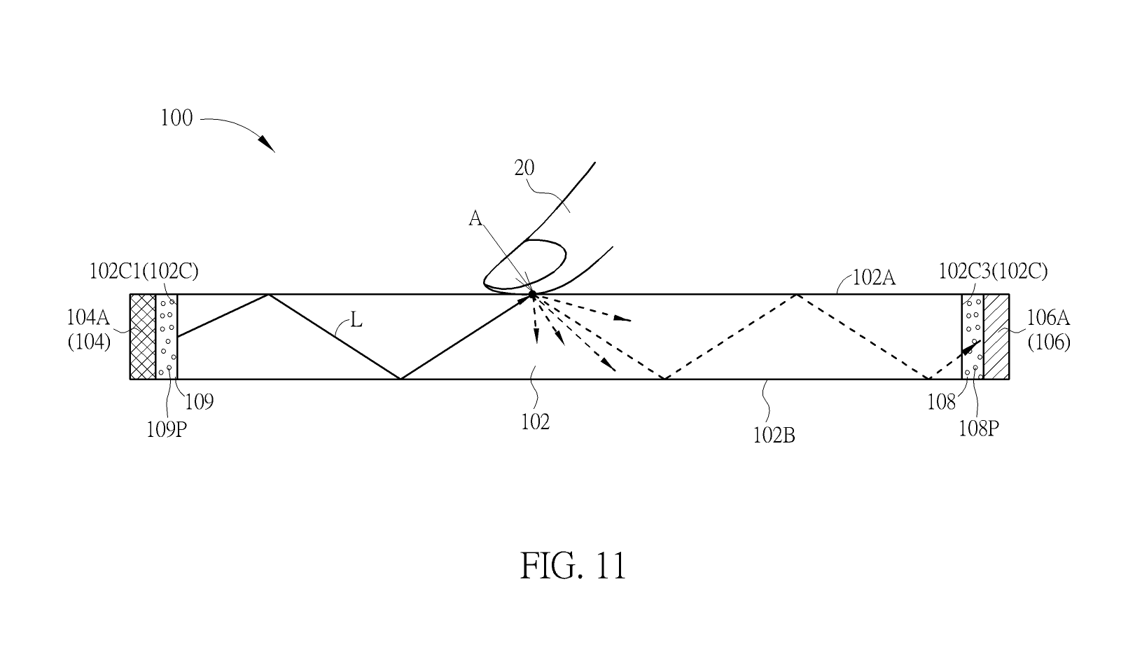

Refer to FIGS. 9-11. FIG. 9 and FIG. 10 are schematic diagrams illustrating an optical display panel of a fourth preferred embodiment of the present invention when no touch input is implemented, and FIG. 11 is a schematic diagram illustrating an optical display panel of a fourth preferred embodiment of the present invention when touch input is implemented, where FIG. 9 is a top view and FIG. 10 and FIG. 11 are cross-sectional views. As shown in FIG. 9 and FIG. 10, the optical touch panel 100 includes a transparent light guide plate (LGP) 102, a light emitting array 104, a light sensing array 106 and a first light coupling layer 108 (shown in FIG. 10). The transparent LGP 102 has a top surface 102A, a bottom surface 102B and a plurality of side surfaces 102C connected to the top surface 102A and the bottom surface 102B. The top surface 102A has a touch input region 102T for touch inputting. The side surfaces 12C of the transparent LGP 102 includes a first side surface 102C1, a second side surface 102C2, a third side surface 102C3 and a fourth side surface 102C4, where the first side surface 102C1 and the third side surface 102C3 are oppositely disposed, and the second side surface 102C2 and the fourth side surface 102C4 are oppositely disposed. The light emitting array 104 includes a plurality of light emitting devices 104A for emitting a light beam L toward the transparent LGP 102. The light sensing array 106 includes a plurality of light sensing devices 106A for sensing the light beam L coming out of the transparent LGP 102. The first light coupling layer 108 is disposed between the transparent LGP 102 and the light sensing array 106 for coupling the light beam L from the transparent LGP 102 to the light sensing array 106. Specifically, the first light coupling layer 108 is able to increase the amount of light beam L exiting from the transparent LGP 102. The first light coupling layer 108 may be, for instance, optical clear adhesive (OCA) containing scattering particles, but not limited thereto. In another embodiment, the first light coupling layer 108 may be optical clear adhesive excluding scattering particles, which can increase the amount of light beam L exiting from the transparent LGP 102 by modifying the refractive index. The first light coupling layer 108 may also be a micro scattering structure layer or other structure layer that may increase the amount of the amount of light beam L exiting from the transparent LGP 102. The material of the transparent LGP 102 may be, for example, acrylic resin or glass, but not limited thereto. The light beam L emitted by the light emitting array 104 may be a visible light beam or an invisible light beam e.g. infrared beam, and the light beam L is preferably linear light beam. The light sensing devices 106A are disposed corresponding to the light emitting devices 104A for sensing the light beam L. For example, the number of the light sensing devices 106A and the number of the light emitting devices 104A may be the same, and each light sensing device 106A and the corresponding light emitting device 104A are disposed oppositely on two opposite sides of the transparent LGP 102. In other words, the light sensing device 106A and the light emitting device 104A are arranged in pairs.

In this embodiment, the light emitting array 104 faces at least one of the side surfaces 102C of the transparent LGP 102, and the light sensing array 106 faces at least one of the side surfaces 102C of the transparent LGP 102. For example, the light emitting devices 104A of the light emitting array 104 face the first side surface 102C1 and the second side surface 102C2 of the transparent LGP 102, the light sensing devices 106A of the light sensing array 106 face the third side surface 102C3 and the fourth side surface 102C4 of the transparent LGP 102, and the light emitting devices 104A are corresponding to the light sensing devices 106A, respectively. In addition, the first light coupling layer 108 is disposed between the third side surface 102C3 and the light sensing devices 106A, and between the fourth side surface 102C4 and the light sensing devices 106A. The optical touch panel 100 may optionally include a second light coupling layer 109 (shown in FIG. 10) disposed between the transparent LGP 102 and the light emitting array 104 to couple the light beam L emitted by the light emitting array 104 to the transparent LGP 102. The second light coupling layer 109 is able to increase the amount of the light beam L entering the transparent LGP 102. For example, the second light coupling layer 109 may be, for instance, optical clear adhesive (OCA) containing scattering particles, but not limited thereto. In another embodiment, the second light coupling layer 109 may be optical clear adhesive excluding scattering particles, which can increase the amount of the light beam L entering the transparent LGP 102 by modifying the refractive index. The second light coupling layer 109 may also be a micro scattering structure layer or other film that may increase the amount of the light beam L entering the transparent LGP 102.

In this embodiment, the refractive index of the transparent LGP 102 is different from the refractive index of a medium layer (e.g. the refractive indeed of air) in contact with the transparent LGP 102. For instance, the refractive index of the transparent LGP 102 is higher than the refractive index of air. As shown in FIG. 10, when no touch input is implemented, total internal reflection (TIR) occurs inside the transparent LGP 102 since the angle of most of the light beam L is greater than the critical angle, and thus most of the light beam L will not come out of the top surface 102A and the bottom surface 102B of the transparent LGP 102. In the side surfaces 102C, however, the light beam L is coupled by the first light coupling layer 108 to exit the transparent LGP 102 so that the light sensing devices 106A can receive the light beam L. Therefore, when no touch input is implemented, the light sensing devices 106A can receive the light beam L with more intensity, which is the basis for determining no touch input is carried out.

As shown in FIG. 11, when a user puts a touch input device 20 such as his finger on an input point A of the top surface 102A of the transparent LGP 102 to implement touch input, the total internal reflection will be destroyed due to the contact of the touch input device 20 and the top surface 102A of the transparent LGP 102. Accordingly, the light beam L at the input point A is scattered by the touch input device 20, and thus the intensity of the light beam L passing through the side surfaces 102C of the transparent LGP 102 is reduced. Therefore, when implementing touch input, two of the light sensing devices 106A will receive the light beam L with lower intensity, which is the basis for determining a touch input occurs at the input point A. Consequently, the coordinates of the touch point A is calculated.

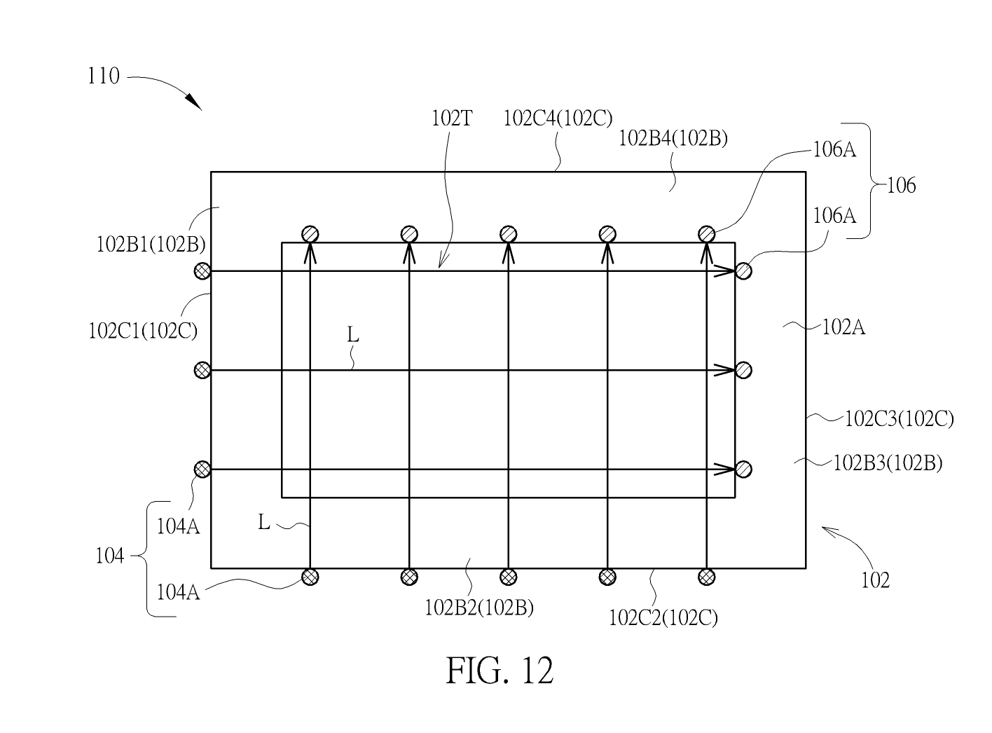

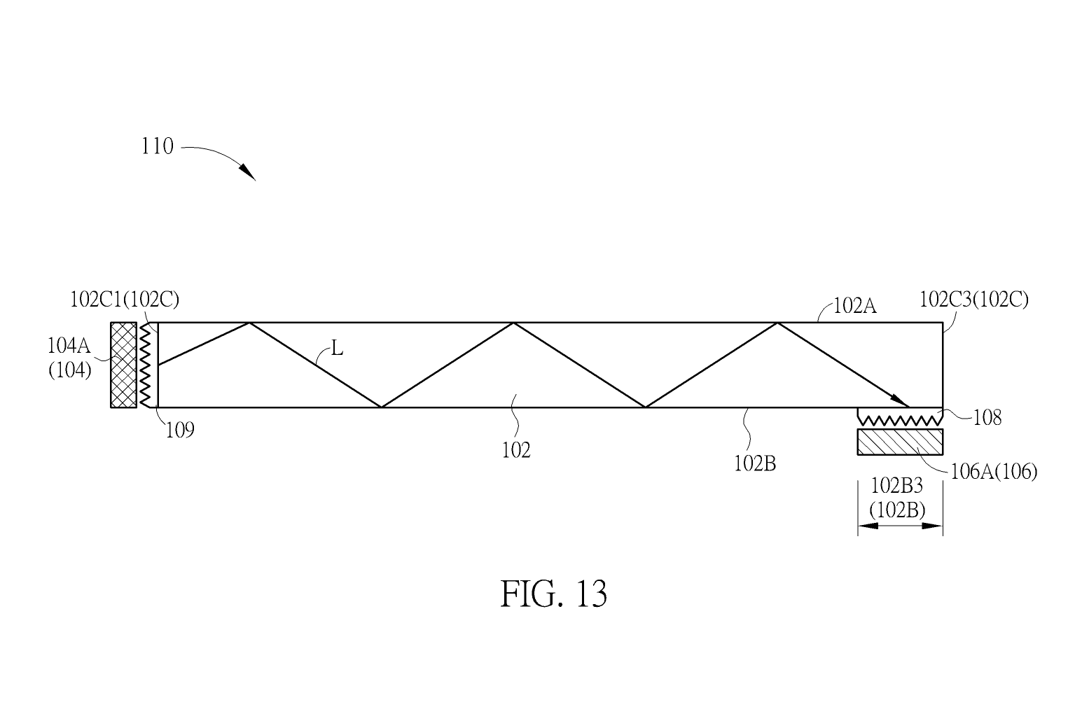

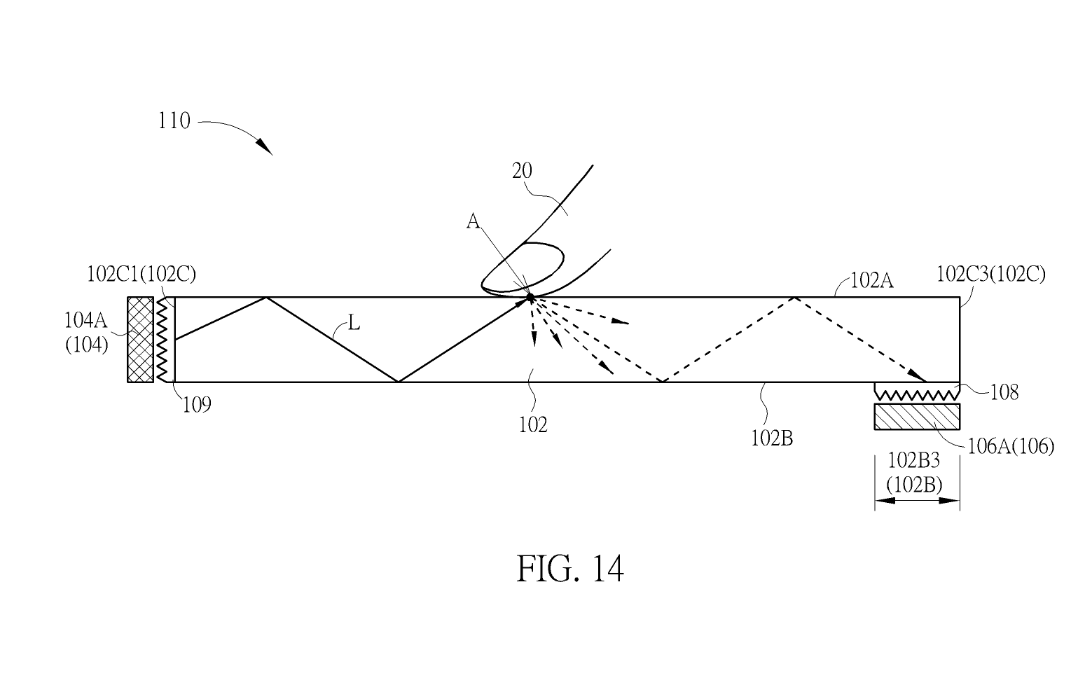

Refer to FIGS. 12-14. FIG. 12 and FIG. 13 are schematic diagrams illustrating an optical touch panel of a fifth preferred embodiment of the present invention when no touch input is implemented, and FIG. 14 is a schematic diagram illustrating an optical touch panel of a fifth preferred embodiment of the present invention when a touch input is implemented. FIG. 12 is a top view of an optical touch panel of a fifth preferred embodiment of the present invention, and FIG. 13 and FIG. 14 are cross-sectional views of an optical touch panel of a fifth preferred embodiment of the present invention. As shown in FIG. 12 and FIG. 13, different from the aforementioned embodiment, in the optical touch panel 110 of this embodiment, the light emitting array 104 faces at least one of the side surfaces 102C of the transparent LGP 102, and the light sensing array 106 faces the bottom surface 102B of the transparent LGP 102. For example, the bottom surface 102B of the transparent LGP 102 has a first peripheral region 102B1, a second peripheral region 102B2, a third peripheral region 102B3 and a fourth peripheral region 102B4 disposed adjacent to the first side surface 102C1, the second side surface 102C2, the third side surface 102C3 and the fourth side surface 102C4, respectively. The first peripheral region 102B1, the second peripheral region 102B2, the third peripheral region 102B3 and the fourth peripheral region 102B4 may surround the touch input region 102T. The light emitting devices 104A of the light emitting array 104 face the first side surface 102C1 and the second side surface 102C2 of the transparent LGP 102, the light sensing devices 106A of the light sensing array 106 face the third peripheral region 102B3 and the fourth peripheral region 102B4 of the bottom surface 102 of the transparent LGP 102, and the light emitting devices 104A are corresponding to the light sensing devices 106A, respectively. In addition, the first light coupling layer 108 is disposed between the third peripheral region 102B3 of the bottom surface 102B and the light sensing device 106A, and between the fourth peripheral region 102B4 of the bottom surface 102B and the light sensing device 106A. In this embodiment, the first light coupling layer 108 and the second light coupling layer 109 may be micro scattering structure layers, but not limited thereto. In other embodiment, the first light coupling layer 108 and the second light coupling layer 109 may be optical clear adhesives with or without scattering particles.

As shown in FIG. 13, when no touch input is implemented, total internal reflection (TIR) occurs inside the transparent LGP 102 since the angle of most of the light beam L is greater than the critical angle, and thus most of the light beam L will not come out of the top surface 102A and the bottom surface 102B of the transparent LGP 102. In the side surfaces 102C, however, the light beam L is coupled by the first light coupling layer 108 to exit the transparent LGP 102 so that the light sensing devices 106A can receive the light beam L. Therefore, when no touch input is implemented, the light sensing devices 106A can receive the light beam L with more intensity, which is the basis for determining no touch input is carried out.

As shown in FIG. 14, when a user puts a touch input device 20 such as his finger on an input point A of the top surface 102A of the transparent LGP 102 to implement touch input, the total internal reflection will be destroyed due to the contact of the touch input device 20 and the top surface 102A of the transparent LGP 102. Accordingly, the light beam L at the input point A is scattered by the touch input device 20, and thus the intensity of the light beam L passing through the side surfaces 102C of the transparent LGP 102 is reduced. Therefore, when implementing touch input, two of the light sensing devices 106A will receive the light beam L with lower intensity, which is the basis for determining a touch input occurs at the input point A. Consequently, the coordinates of the touch point A is calculated.

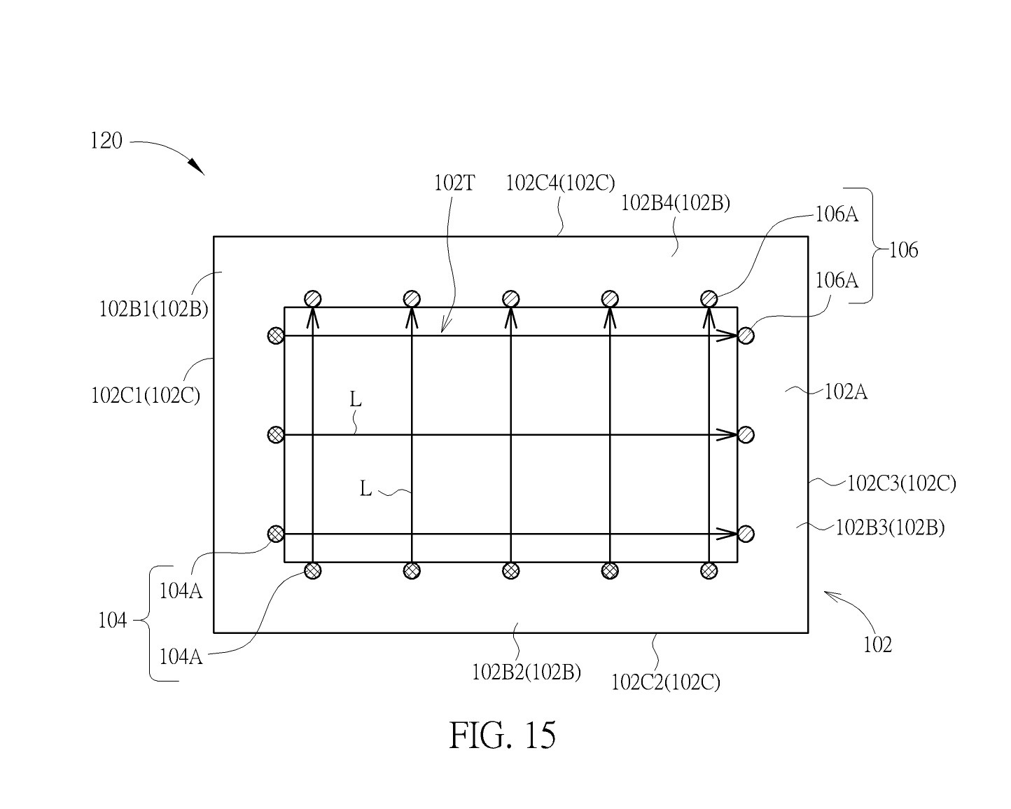

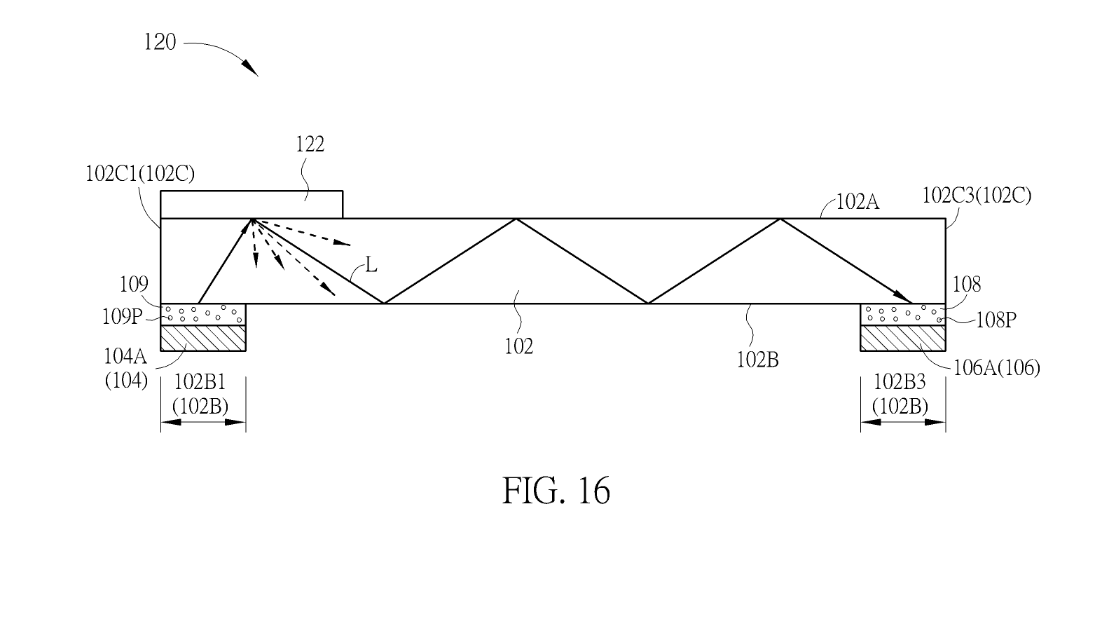

Refer to FIG. 15 and FIG. 16. FIG. 15 and FIG. 16 are schematic diagrams illustrating an optical touch panel of a sixth preferred embodiment of the present invention, where FIG. 15 is a top view of an optical touch panel of a sixth preferred embodiment of the present invention, and FIG. 16 is a cross-sectional view of an optical touch panel of a sixth preferred embodiment of the present invention. As shown in FIG. 15 and FIG. 16, different from the aforementioned embodiment, in the optical touch panel 120 of this embodiment, the light emitting array 104 faces the bottom surface 102B of the transparent LGP 102, and the light sensing array 106 faces the bottom surface 102B of the transparent LGP 102. For example, the light emitting devices 104A of the light emitting array 104 face the first peripheral region 102B1 and the second peripheral region 102B2 of the bottom surface 102 of the transparent LGP 102, the light sensing devices 106A of the light sensing array 106 face the third peripheral region 102B3 and the fourth peripheral region 102B4 of the bottom surface 102 of the transparent LGP, and the light emitting devices 104A are corresponding to the light sensing devices 106A, respectively. In addition, the first light coupling layer 108 is disposed between the third peripheral region 102B3 of the bottom surface 102B and the light sensing device 106A, and between the fourth peripheral region 102B4 of the bottom surface 102B and the light sensing device 106A. The second light coupling layer 109 (shown in FIG. 16) is disposed between the transparent LGP 102 and the light emitting array 104 for coupling the light beam L emitted by the light emitting array 104 to the transparent LGP 102. In this embodiment, the second light coupling layer 109 may be an optical clear adhesive with or without scattering particles, but not limited thereto. In other embodiment, the second light coupling layer 109 may be a micro scattering structure layer or any film that can increase the amount of the light beam L entering the transparent LGP 102. Furthermore, the optical touch panel 120 may optionally include a light scattering layer 122 disposed on the top surface 102A of the transparent LGP 102 and corresponding to the light emitting array 104 for scattering the light beam L inside the transparent LGP 102 without coming out of the top surface 102A. The light scattering layer 122 may be a reflective layer with micro structures, but not limited thereto. The touch input mechanism of the optical touch panel 120 of this embodiment is similar to that of the aforementioned embodiment, and thus is not redundantly described.

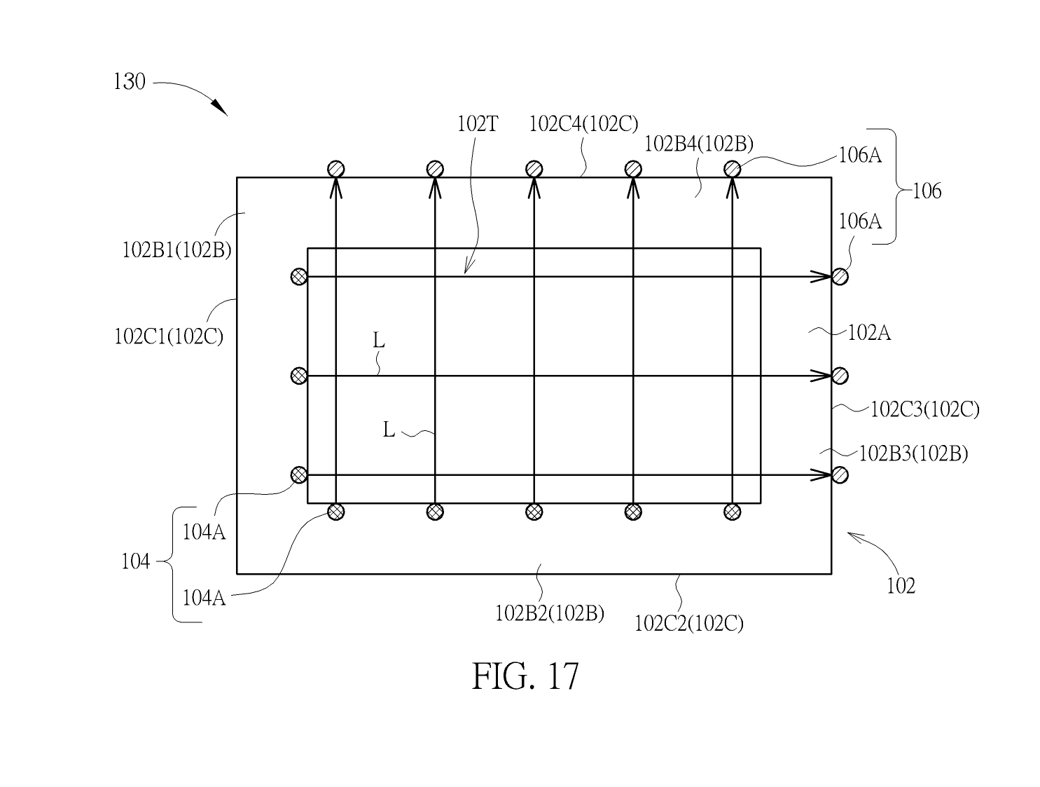

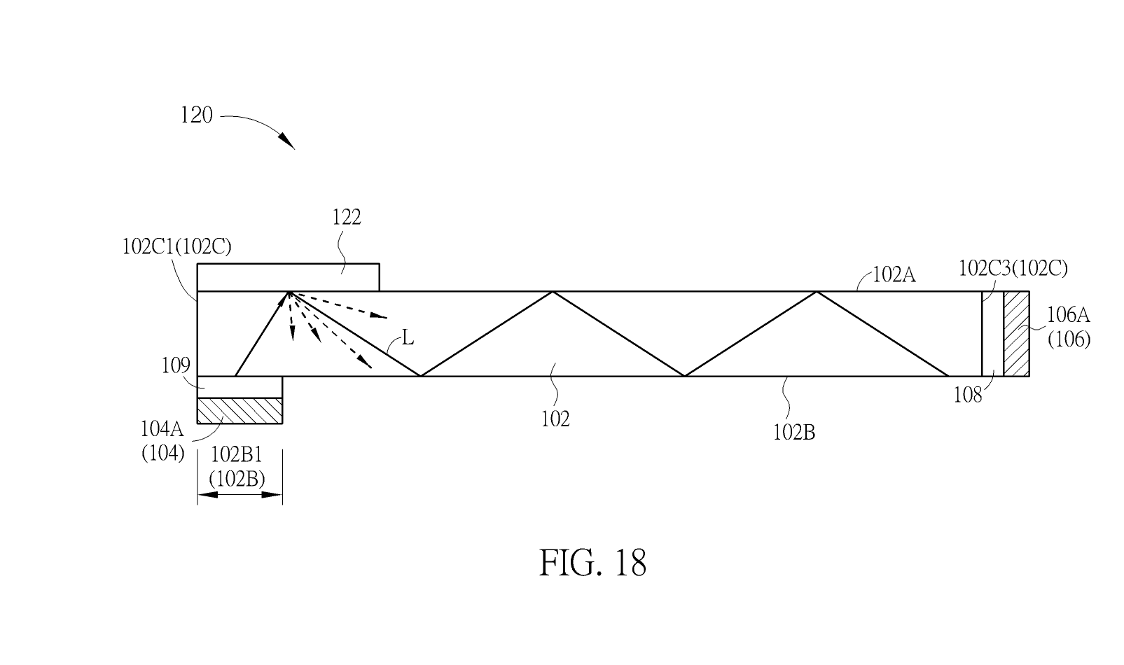

Refer to FIG. 17 and FIG. 18. FIG. 17 and FIG. 18 are schematic diagrams illustrating an optical touch panel of a seventh preferred embodiment of the present invention, where FIG. 17 is a top view of an optical touch panel of a seventh preferred embodiment of the present invention, and FIG. 18 is a cross-sectional view of an optical touch panel of a seventh preferred embodiment of the present invention. As shown in FIG. 17 and FIG. 18, different from the aforementioned embodiment, in the optical touch panel 130 of this embodiment, the light emitting array 104 faces the bottom surface 102B of the transparent LGP 102, and the light sensing array 106 faces at least one of the side surfaces 102C of the transparent LGP 102. For example, the light emitting devices 104A of the light emitting array 104 face the first peripheral region 102B1 and the second peripheral region 102B2 of the bottom surface 102B of the transparent LGP 102, the light sensing devices 106A of the light sensing array 106 face the third side surface 102C3 and the fourth side surface 102C4 of the transparent LGP 102, and the light emitting devices 104A are corresponding to the light sensing devices 106A, respectively. In addition, the first light coupling layer 108 is disposed between the third side surface 102C3 and the light sensing device 106A, and between the fourth side surface 102C4 and the light sensing device 106A. The second light coupling layer 109 (shown in FIG. 18) is disposed between the transparent LGP 102 and the light emitting array 104 for coupling the light beam L emitted by the light emitting array 104 to the transparent LGP 102. In this embodiment, the second light coupling layer 109 may be an optical clear adhesive without scattering particles, but not limited thereto. In other embodiment, the second light coupling layer 109 may be an optical clear adhesive with scattering particles or a micro scattering structure layer or any film that can increase the amount of the light beam L entering the transparent LGP 102. Furthermore, the optical touch panel 130 may optionally include a light scattering layer 122 disposed on the top surface 102A of the transparent LGP 102 and corresponding to the light emitting array 104 for scattering the light beam L inside the transparent LGP 102 without coming out of the top surface 102A. The light scattering layer 122 may be a reflective layer with micro structures, but not limited thereto. The touch input mechanism of the optical touch panel 130 of this embodiment is similar to that of the aforementioned embodiment, and thus is not redundantly described.

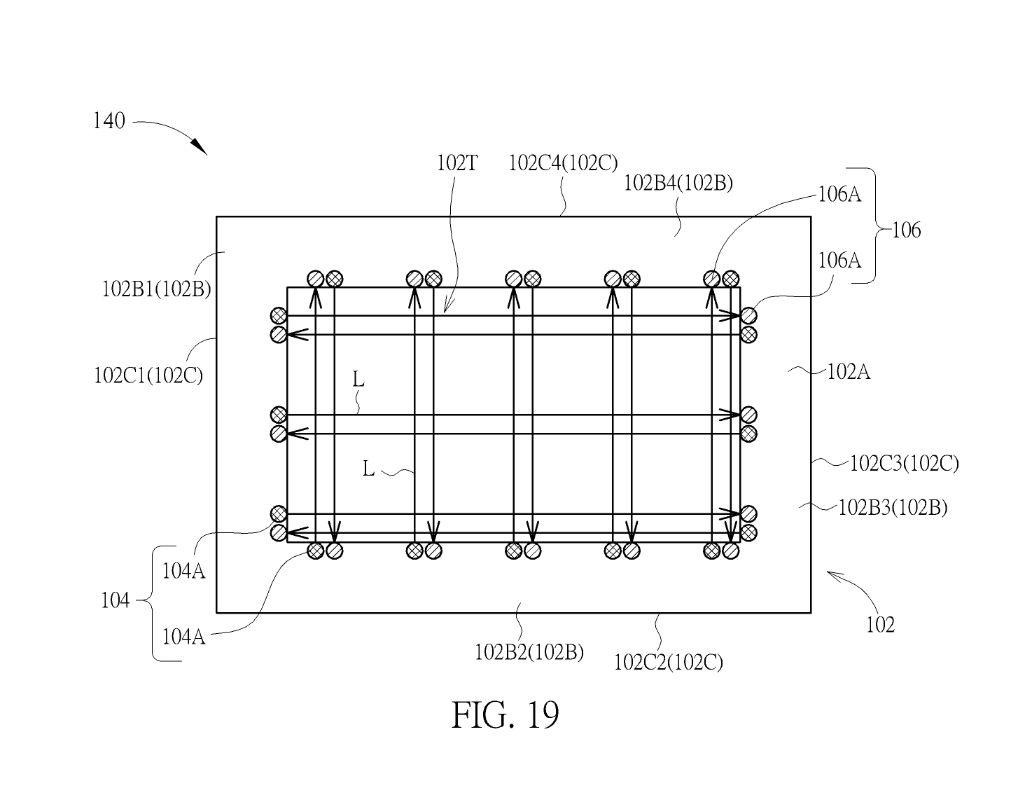

Refer to FIG. 19. FIG. 19 is a schematic diagram illustrating an optical touch panel of an eighth preferred embodiment of the present invention. As shown in FIG. 19, different from the aforementioned embodiment, in the optical touch panel 140 of this embodiment, the light emitting devices 104A of the light emitting array 104 face the first peripheral region 102B1, the second peripheral region 102B2, the third peripheral region 102B3 and the fourth peripheral region 102B4 of the bottom surface 102B of the transparent LGP 102, the light sensing devices 106A of the light sensing array 106 face the first peripheral region 102B1, the second peripheral region 102B2, the third peripheral region 102B3 and the fourth peripheral region 102B4 of the bottom surface 102B of the transparent LGP 102, and the light emitting devices 104A are corresponding to the light sensing devices 106A, respectively. In other words, the light emitting devices 104A and the light sensing devices 106A are arranged alternately in the peripheral region. In a modified embodiment, the light emitting devices 104A of the light emitting array 104 may face the first side surface 102C1, the second side surface 102C2, the third side surface 102C3 and the fourth side surface 102C4 of the transparent LGP 102, and the light sensing devices 106A of the light sensing array 106 may face the first side surface 102C1, the second side surface 102C2, the third side surface 102C3 and the fourth side surface 102C4 of the transparent LGP 102. In other words, the light emitting devices 104A and the light sensing devices 106A are arranged alternately in the side surface.

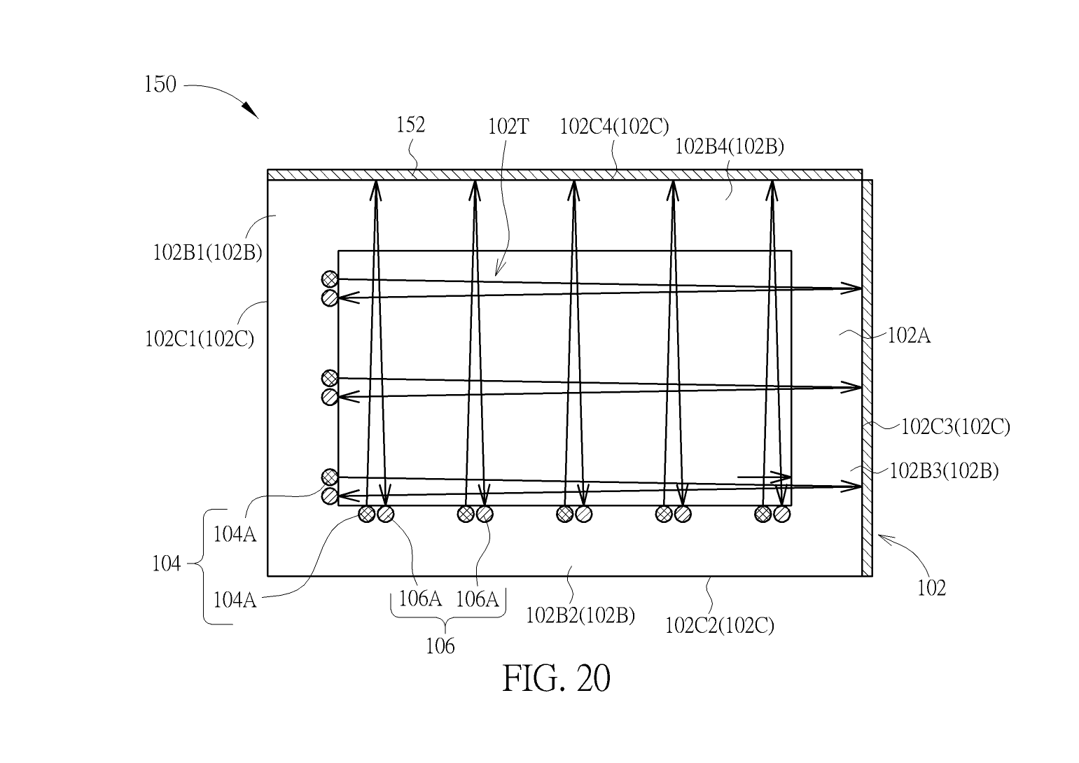

Refer to FIG. 20. FIG. 20 is a schematic diagram illustrating an optical touch panel of a ninth preferred embodiment of the present invention. As shown in FIG. 20, different from the aforementioned embodiment, in the optical touch panel 150 of this embodiment, the light emitting devices 104A of the light emitting array 104 face the first peripheral region 102B1 and the second peripheral region 102B2 of the bottom surface 102 of the transparent LGP 102, and the light sensing devices 106A of the light sensing array 106 face the first peripheral region 102B1 and the second peripheral region 102B2 of the bottom surface 102 of the transparent LGP 102, and the light emitting devices 104A and the light sensing devices 106A are arranged alternately in the peripheral region. The optical touch panel 150 further includes a reflective sheet 152 disposed on the third side surface 102C3 and the fourth side surface 102C4 of the transparent LGP 102 for reflecting the light beam L emitted by the light emitting devices 104A to the light sensing devices 106A. In a modified embodiment, the light emitting devices 104A of the light emitting array 104 may face the first side surface 102C1 and the second side surface 102C2 of the transparent LGP 102, the light sensing devices 106A of the light sensing array 106 may face the first side surface 102C1 and the second side surface 102C2 of the transparent LGP 102, and the reflective sheet 152 is disposed on the third side surface 102C3 and the fourth side surface 102C4 of the transparent LGP 102 for reflecting the light beam L emitted by the light emitting devices 104A to the light sensing devices 106A .

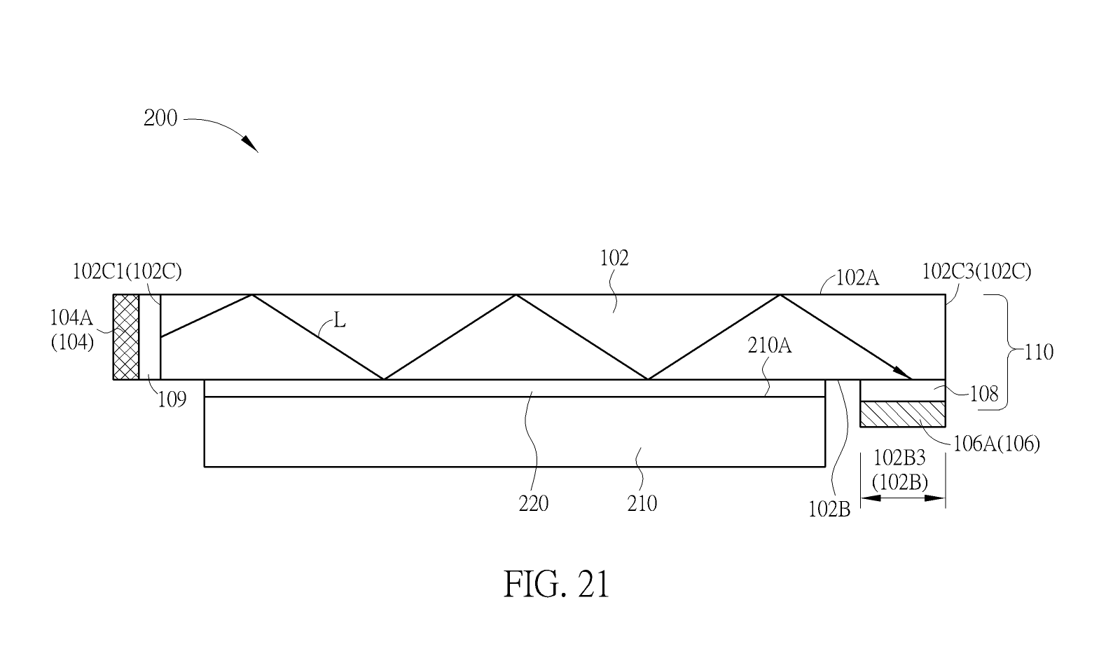

Refer to FIG. 21. FIG. 21 is a schematic diagram of a touch display panel of a second preferred embodiment of the present invention. As shown in FIG. 21, the touch display panel 200 includes a display panel 210 and an optical touch panel 110. The display panel 210 has a display surface 210A. The display panel 210 may be a self-luminous display panel such as organic electroluminescent display panel, plasma display panel, field emitting display panel, etc., or a non self-luminous display panel such as a liquid crystal display panel, an electrowetting display panel, an electrophoretic display panel, etc. In this embodiment, the optical touch panel 110 is selected from the optical touch panel of FIG. 13, but not limited. For example, the optical touch panel 110 may be selected from any one of the optical touch panels of FIGS. 9-20. The components and arrangement of the optical touch panel 110 are illustrated in the aforementioned embodiments, and are not redundantly described. Also, in order to preventing the light beam L emitted by the optical touch panel 110 from exiting through the bottom surface 102B of the transparent LGP 102, the touch display panel 200 may further include a medium layer 220 disposed between the display surface 210A of the display panel 210 and the bottom surface 102B of the transparent LGP 102. The refractive index of the medium layer 220 is lower than the refractive index of the transparent LGP 102, and thus the light beam L do not exit the bottom surface 102B of the transparent LGP 102 due to total internal reflection.

The touch display panel and the optical touch panel disclosed in FIGS. 9-21 of the present invention dispose the light emitting array and the light sensing array on the side surface or the peripheral region of the bottom surface of the transparent LGP, and thus the border can be reduced to satisfy the slim border requirement. In addition, the aperture ratio of the display panel remains unaffected and the touch display panel has full flat surface display effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical touch panel, comprising:
a transparent light guide plate having a top surface, a bottom surface and at least one light incident surface, wherein the top surface is for touch inputting;
at least one light emitting device facing the light incident surface of the transparent light guide plate for emitting a light beam toward the light incident surface;
a bottom reflective sheet facing the bottom surface of the transparent light guide plate, wherein a light reflection space exists between the bottom surface of the transparent light guide plate and the bottom reflective sheet; and
at least one light sensing device disposed on at least one side of the light reflection space for sensing the light beam reflected by the light reflection space.

2. The optical touch panel of claim 1, wherein the at least one light emitting device comprises two light emitting devices, respectively disposed at two adjacent corners of the transparent light guide plate.

3. The optical touch panel of claim 1, wherein the at least one light emitting device comprises two light emitting devices, respectively disposed on two adjacent light incident surfaces of the transparent light guide plate.

4. The optical touch panel of claim 1, wherein the at least one light emitting device comprises four light emitting devices, respectively disposed on four adjacent light incident surfaces of the transparent light guide plate.

5. The optical touch panel of claim 1, wherein the at least one light sensing device comprises two or more light sensing devices, respectively disposed at two adjacent corners of the light reflection space.

6. The optical touch panel of claim 1, wherein the light incident surface of the transparent light guide plate has a plurality of micro structures for diffusing the light beam entering the transparent light guide plate.

7. The optical touch panel of claim 1, wherein the light beam emitted by the light emitting device comprises a visible light beam or an invisible light beam.

8. The optical touch panel of claim 1, further comprising a side reflective sheet, wherein the transparent light guide plate has at least one side surface, and the side reflective sheet is disposed on the side surface of the transparent light guide plate for reflecting the light beam.

9. A touch display panel, comprising:
a display panel having a display surface; and
the optical touch panel of claim 1, wherein the bottom surface of the transparent light guide plate faces the display surface of the display panel.

10. A touch display panel, comprising:
a display panel having a display surface; and
an optical touch panel, comprising:
a transparent light guide plate having a top surface, a bottom surface and at least one light incident surface, wherein the top surface is for touch inputting, the bottom surface faces the display surface of the display panel, and an light reflection space exists between the bottom surface and the display surface of the display panel;
at least one light emitting device facing the light incident surface of the transparent light guide plate for emitting a light beam toward the light incident surface; and
at least one light sensing device disposed on at least one side of the light reflection space for sensing the light beam reflected by the light reflection space.

11. An optical touch panel, comprising:
a transparent light guide plate having a top surface, a bottom surface and a plurality of side surfaces connected to the top surface and the bottom surface, wherein the top surface is for touch inputting;
a light emitting array for emitting a light beam toward the transparent light guide plate, wherein the light emitting array comprises a plurality of light emitting devices;
a light sensing array for sensing the light beam coming out of the transparent light guide plate, wherein the light sensing array comprises a plurality of light sensing devices; and
a first light coupling layer disposed between the transparent light guide plate and the light sensing array for coupling the light beam inside the transparent light guide plate to the light sensing array.

12. The optical touch panel of claim 11, wherein the light emitting array faces at least one of the side surfaces of the transparent light guide plate, and the light sensing array faces at least one of the side surfaces of the transparent light guide plate or the bottom surface of the transparent light guide plate.

13. The optical touch panel of claim 11, wherein the light emitting array faces the bottom surface of the transparent light guide plate, and the light sensing array faces at least one of the side surfaces of the transparent light guide plate or the bottom surface of the transparent light guide plate.

14. The optical touch panel of claim 13, further comprising a light scattering layer disposed on the top surface of the transparent light guide plate and corresponding to the light emitting array for scattering the light beam inside the transparent light guide plate.

15. The optical touch panel of claim 11, wherein the first light coupling layer comprises an optical clear adhesive or a micro scattering structure layer.

16. The optical touch panel of claim 15, wherein the optical clear adhesive comprises scattering particles.

17. The optical touch panel of claim 11, further comprising a second light coupling layer disposed between the transparent light guide plate and the light emitting array for coupling the light beam emitted by the light emitting array to the transparent light guide plate.

18. The optical touch panel of claim 17, wherein the second light coupling layer comprises an optical clear adhesive or a micro scattering structure layer.

19. The optical touch panel of claim 18, wherein the optical clear adhesive comprises scattering particles.

20. The optical touch panel of claim 11, wherein the side surfaces of the transparent light guide plate comprise a first side surface, a second side surface, a third side surface and a fourth side surface, the first side surface is opposite to the third side surface, the second side surface is opposite to the fourth side surface, the bottom surface of the transparent light guide plate comprises a first peripheral region, a second peripheral region, a third peripheral region and a fourth peripheral region disposed adjacent to the first side surface, the second side surface, the third side surface and the fourth side surface, respectively.

21. The optical touch panel of claim 20, wherein the light emitting devices of the light emitting array face the first side surface and the second side surface of the transparent light guide plate, the light sensing devices of the light sensing array face the third side surface and the fourth side surface of the transparent light guide plate, and the light emitting devices are corresponding to the light sensing devices, respectively.

22. The optical touch panel of claim 20, wherein the light emitting devices of the light emitting array face the first side surface and the second side surface of the transparent light guide plate, the light sensing devices of the light sensing array face the third peripheral region and the fourth peripheral region of the bottom surface of the transparent light guide plate, and the light emitting devices are corresponding to the light sensing devices, respectively.

23. The optical touch panel of claim 20, wherein the light emitting devices of the light emitting array face the first peripheral region and the second peripheral region of the bottom surface of the transparent light guide plate, the light sensing devices of the light sensing array face the third peripheral region and the fourth peripheral region of the bottom surface of the transparent light guide plate, and the light emitting devices are corresponding to the light sensing devices, respectively.

24. The optical touch panel of claim 20, wherein the light emitting devices of the light emitting array face the first peripheral region and the second peripheral region of the bottom surface of the transparent light guide plate, the light sensing devices of the light sensing array face the third side surface and the fourth side surface of the transparent light guide plate, and the light emitting devices are corresponding to the light sensing devices, respectively.

25. The optical touch panel of claim 20, wherein the light emitting devices of the light emitting array face the first peripheral region, the second peripheral region, the third peripheral region and the fourth peripheral region of the bottom surface of the transparent light guide plate, the light sensing devices of the light sensing array face the first peripheral region, the second peripheral region, the third peripheral region and the fourth peripheral region of the bottom surface of the transparent light guide plate, and the light emitting devices are corresponding to the light sensing devices, respectively.

26. The optical touch panel of claim 20, further comprising a reflective sheet, wherein the light emitting devices of the light emitting array face the first peripheral region and the second peripheral region of the bottom surface of the transparent light guide plate, the light sensing devices of the light sensing array face the first peripheral region and the second peripheral region of the bottom surface of the transparent light guide plate, and the reflective sheet is disposed on the third side surface and the fourth side surface of the transparent light guide plate for reflecting the light beam emitted by the light emitting devices to the light sensing devices.

27. A touch display panel, comprising:
a display panel having a display surface; and
the optical touch panel of claim 11, wherein the bottom surface of the transparent light guide plate faces the display surface of the display panel.

28. The touch display panel of claim 27, further comprising a medium layer disposed between the display surface of the display panel and the bottom surface of the transparent light guide plate, wherein a refractive index of the medium layer is lower than that of the transparent light guide plate.
